(19) United States
(12) Patent Application Publication
(10) Pub. No.: US 2015/0078375 A1
(43) Pub. Date: Mar. 19, 2015

(54) Mutable Hash for Network Hash Polarization

(71) Applicant: Broadcom Corporation, Irvine, CA (US)

(72) Inventor: Ariel HENDEL, Cupertino, CA (US)

(73) Assignee: Broadcom Corporation, Irvine, CA (US)

(21) Appl. No.: 14/026,725

(22) Filed: Sep. 13, 2013

(51) Int. Cl. H04L 12/743

(52) U.S. Cl. CPC H04L 45/7453
USPC 370/389

(57) ABSTRACT

A system, method and a computer readable medium for reducing hash polarization in a network, are provided. A field in a packet is identified at a first device in a network that propagates the packet though the network. The field is immutable at the first device in a network but is mutable as the packet propagates to other devices. Based on a value of the field, a hash function is selected from multiple hash functions such that a different hash function is selected for a different value of the field. The selected hash function determines a resource within the first device that identifies one of the other devices in the network next to receive the packet from the first device.

### BACKGROUND

1. Field

The embodiments relate to packet transmission in a network, and more specifically to avoiding hash polarization at devices transmitting packets through the network.

2. Related Art

Computer networks suitable for cloud computing require a scalable network infrastructure that hosts traditional and distributed applications. These networks may be implemented within data centers, and also as networks that send and transmit data over the Internet or the World Wide Web.

The network data traffic travels along multiple possible paths from a source to a destination. For example, data traffic travels from a source to destination through a series of switches, where each switch has numerous ports for sending and receiving data traffic to and from other switches. For example, in a CLOS network a switch may have N ports, where N/2 ports are ports that interface the tier below the switch and N/2 ports are ports that interface switches in a tier above the switch towards a destination.

Data traffic in a network travels in sequential or non-sequential data flows. Whether the data traffic is sequential or non-sequential depends on a network protocol type. To ensure a sequential data flow, sequential data travels through a network along the salt e path. When multiple data flows converge on a particular port of a switch or a router at a time, the network may become congested and unbalanced. Because a large fraction of the data traffic in the Internet or within data centers uses the transmission control protocol (“TCP”) (and requires sequential transmission), packets simply cannot be dispersed though the network using a dispersion function to avoid network congestion. Dispersing TCP packets along separate paths cannot ensure that the TCP packets would arrive at a destination in a sequential order, which in turn will cause the TCP to slow data transmission. This is the case because TCP packets that arrive out of order are treated the same way as lost packets, and therefore cause the destination to issue a request for packet retransmission. When the source receives multiple retransmission requests (typically three), the source assumes network congestion and slows the packet transmission rate.

To load balance data traffic (i.e. multiple data flows) in a network, multiple data flows are forced to travel along different paths. For sequential data flows, packets that arrive at a particular switch are subject to a calculation using a static hash function. The hash function is applied to a field or a subset of fields in a packet and selects an outgoing port that leads to the next switch or a destination based on the value of the hash. For example, the static hash function is applied to a predetermined immutable field or a subset of immutable fields that are included in each packet of a data flow, and a modulus operation of the hash is taken to limit the range of selection to that of the relevant ports. The value of the modulus calculation corresponds to the outgoing port though which the packet travels to the next switch. Because all packets in a sequential data flow have the same immutable field or fields in their headers, the hash function ensures that the packets in the data flow travel along the same path. Because the same static function is applied to the same immutable field in each packet of the data flow at each stage in a network, the data flow always travels along the same path and through the same ports.

However, because the same static hash function is applied to the same immutable fields in the data flow, a conventional network experiences hash polarization. For example, packets from two different data flows may generate the same static hash function, and be propagated along the same port to the next switch. At the next switch, the static hash function will again be applied to the same immutable fields for packets in both data flows, and again will generate the same result that maps to the same port therefore the flows do not separate at said next switch. This will cause the packets from different data flows to travel along the same port to another switch, and so forth. When applied to multiple data flows, congestion also known as hash polarization occurs when multiple data flows attempt to reach switches via the same ports. The source of such polarization is that the decisions resulting from static functions are correlated, and the use of local seeds in general does not remove the correlation.

### BRIEF SUMMARY

A system, method and a computer readable medium for reducing hash polarization in a network, are provided. A field in a packet is identified at a first device in a network that propagates the packet though the network. The field is immutable at the first device in a network, but is mutable as the packet propagates to other devices. Based on a value of the field, a hash function is selected from multiple hash functions such that a different hash function is selected for a different value of the field. The selected hash function determines a resource within the first device that identifies one of the other devices in the network that will receive the packet from the first device.

In a further embodiment, a source that initiates the transmission of the packet sets the value of the field to a value larger than a network diameter. The source also deliberately sets different values to the field in different packets in the same data flow. This ensures that different packets in data flow that can travel without a sequential constraint, along different paths in the network from the source to the destination.

Further features and advantages of the embodiments, as well as the structure and operation of various embodiments, are described in detail below with reference to the accompanying drawings. It is noted that the embodiments are not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form part of the specification, illustrate the embodiments and, together with the description, further serve to explain the principles of the embodiments and to enable a person skilled in the pertinent art to make and use the embodiments. Various embodiments are described below with reference to the drawings, wherein like reference numerals are used to refer to like elements throughout.

FIG. 1 is a block diagram of a packet switched network, according to an embodiment.

FIG. 2 is a block diagram of a hash generator, according to an embodiment.

FIG. 3 is a block diagram of a hardware implementation of a hash function selector, according to an embodiment.

FIG. 4 is a block diagram of a source that generates a value for a field in a packet, according to an embodiment.

FIG. 5 is a flowchart of a method for selecting a resource, according to an embodiment.

FIG. 6 is an example computer system in which the embodiments can be implemented.

FIG. 7 is an example of a switch or a router system in which the embodiments can be implemented.

The embodiments will be described with reference to the accompanying drawings. Generally, the drawing in which an element first appears is typically indicated by the leftmost digit(s) in the corresponding reference number.

### DETAILED DESCRIPTION

In the detailed description that follows, references to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The term “embodiments” does not require that all embodiments include the discussed feature, advantage or mode of operation. Alternate embodiments may be devised without departing from the scope of the disclosure, and well-known elements of the disclosure may not be described in detail or may be omitted so as not to obscure the relevant details. In addition, the terminology used herein is for the purpose of describing particular embodiments only and is not intended to be limiting of the disclosure. For example, as used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

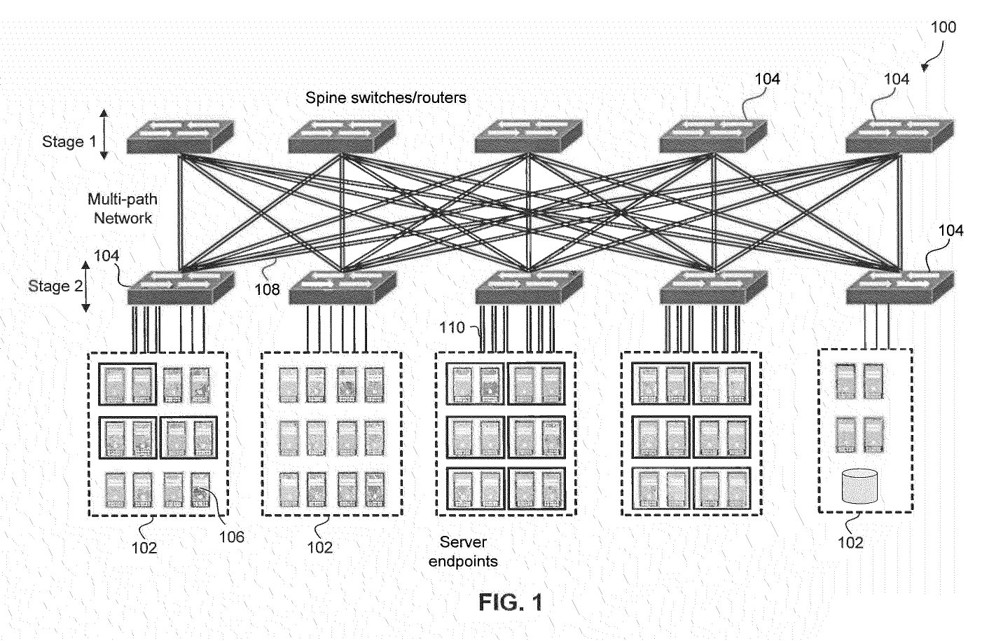

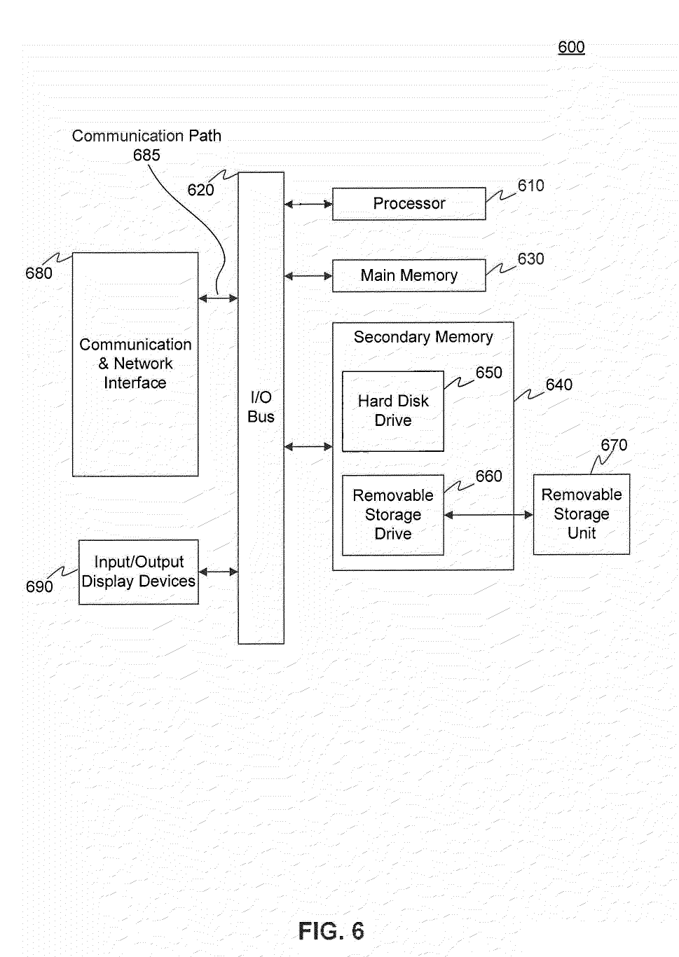

FIG. 1 is a block diagram of a packet switch network 100, according to an embodiment. Example network 100 connects multiple servers within a data center. A data center is a facility that includes multiple server racks 102 that include multiple servers 106. Servers 106 are computers that host computer systems that store data, execute applications, provide services to other computing devices, such as mobile devices, desktop devices, laptop devices, set-top boxes, other servers, etc. Example server 106 is included in FIG. 6.

In an embodiment, data centers may also include power supplies, communication connects, environment controls for the servers and cyber security devices, storage systems, etc.

Network 100 allows data traffic to travel between servers 106 in the same or different server racks 102. Example network 100 may be a local area network (LAN), wide area network (WAN), storage area network (SAN), etc. Network 100 may be a mesh network, though an implementation is not limited to this embodiment.

In an embodiment, network 100 includes multiple switches 104 that are connected by links 108. Switches 104 and links 108 connect servers 106 located in the same or different server racks 102 and allow for data to travel among servers 106. When data traffic travels from one switch 104 to another switch 104 via link 108, the traversal is considered a network hop. In an embodiment, data may travel from server 106 to the first switch 104 and then individual hops though multiple switches 104 until it reaches a destination, which is another server 106 that receives the data. Each server 106 and its components or applications may typically act as both a source and a destination. A hop is a datapath increment between devices in a network, i.e. between switches or routers.

In an embodiment, network 100 may be a multi-stage network. In a multi-stage network, switches 104 at stage 2 connect to servers 106 using one or more links over network ports 110. Data then travels from switch 104 at stage 2 to switches 104 at stage 1, or until data reaches the “spine” which is the top most stage in network 100, and then travels down to destination. For instance, in example FIG. 1, stage 1 is the spine.

In an embodiment, network 100 may be composed of routers instead of switches where there is no distinction in the operational models of a router vs. a switch for our purposes. Routers may connect network 100 with other, same or different, networks for the inter-network data communication. Both switches 104 and routers may be collectively referred to as devices that propagate data in network 100.

In an embodiment, data traffic may be the aggregate of multiple data flows. A data flow is a sequence of packets that start at the same source and arrive at the same destination. In an embodiment, network 100 may transmit data flows having multiple types. Example types may be Transmission Control Protocol and Internet Protocol (TCP/IP), User Datagram Protocol (UDP) data traffic, and Hypertext Transfer Protocol (HTTP) data traffic. Some data flow types, such as TCP/IP, have a sequential packet ordering constraint that requires that packets be received sequentially, at a destination. When a destination receives an out of order TCP/IP packet, the destination presumes packet loss and issues a retransmission request. Other data flow types, such as UDP and some used of HTTP data traffic may not have a sequential packet constraint. When sequential packet constraints are absent, the destination node may receive packets in any order with no adverse consequences.

In an embodiment, a packet in a data flow includes a header and data sections. A header may include mutable and immutable fields. In an embodiment, mutable fields change or can be changed as the packet travels through network 100 from one device to the next. In an embodiment, immutable fields are fields that remain constant as the packet travels though network 100 from one device to the next. In a further embodiment, immutable fields may be set by the source and remain constant as the packet travels through network 100 to a destination. Example immutable fields may include a source IP address, a destination IP address, protocol fields, TCP ports, etc. The immutable fields in the packet are conventionally used to enforce ordered packet transmission. Conventionally, when a static hash function is applied to an immutable field or a subset of immutable fields in the packet header, the static function always generates the same result, which ensures the next hop in a network is always the same. This in turn ensures that the data flow travels though the same path in a network.

As switches 104 propagate data from a source to a destination via multiple hops, switches 104 use a static hash function to determine a resource, such as a port though which packets in a data flow will travel to the next switch 104. A person skilled in the art will appreciate that the static hash function is independent of time and data load. However, using a hash function to determine the next port may cause hash polarization. To diffuse hash polarization described in the background section, switches 104 in network 102 include hash generators that, instead of simply applying a hash to immutable fields in the packet, use a packet field that is constant or immutable within switch 104, but is non-constant or mutable as a packet hops from one switch 104 to another switch 104. As discussed below, the field is used to select a hash function in switch 104 prior to applying the selected hash function to the immutable fields.

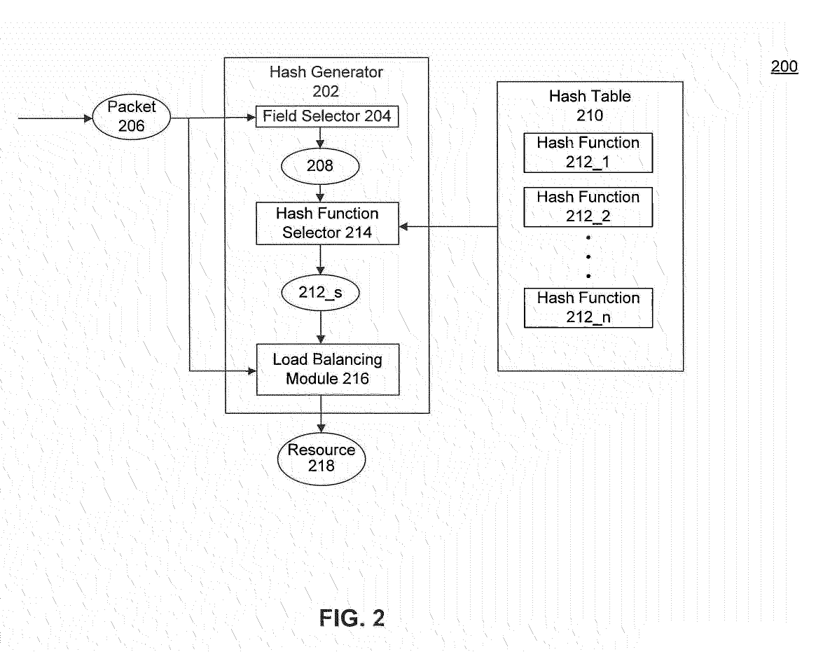

FIG. 2 is a block diagram 200 of a hash generator, according to an embodiment. A hash generator 202 may be included in switch 104 in network 100, in one embodiment. In another embodiment, hash generator 202 may also be included in a router, or another device that propagates data through network 100.

In an embodiment, hash generator 202 includes a field selector 204. Field selector 204 receives a packet 206, as an input and identifies a field 208 in packet 206 that is immutable within switch 104 and mutable between switches 104 in network 100. In an embodiment, field 208 may be included in the header of packet 206. Notably, in a multi-stage network, field 208 is immutable at a particular stage, but is mutable between different stages. Notably, field 208 that is immutable within switch 104 and mutable between switches 104 in network 100 may actually mutate in switch 104, after all processing related to the value of switch 104 completes, in one embodiment. For instance, the value of field 208 may be decremented after all processing related to field 208 on switch 104 completes, and packet 206 is ready to be sent to the next switch 104.

In an embodiment, field 208 may be set to a value of “N” at the source, and then decremented each time a packet makes a hop from switch 104 to another switch 104. Thus, at the first switch the value of field 208 is N-1, at the second switch the value field 208 is N-2, at the third switch the value of field 208 is N-3, etc. In an embodiment, the value of N may be a diameter of network 100. For instance, the diameter of a multi-stage network is the number of hops a packet makes from the source to spine, multiplied by two.

In an embodiment, field 208 may be a time to live (“TTL”) field. A person skilled in the art will appreciate that the TTL field may be included in the packet header. Conventionally, a TTL field limits the lifespan of a packet in a network, in the event the packet enters a forwarding loop and circulates transiently or indefinitely between two or more switches without reaching a destination. Example TTL field may be implemented as a counter that is decremented each time a packet moves from one switch to the next. When the value of the TTL field reaches “0” a device discards the packet. Because the TTL field is decremented at each hop, the value of the TTL field remains constant at each switch 104 in network 100 but is different when packet moves between different switches 104.

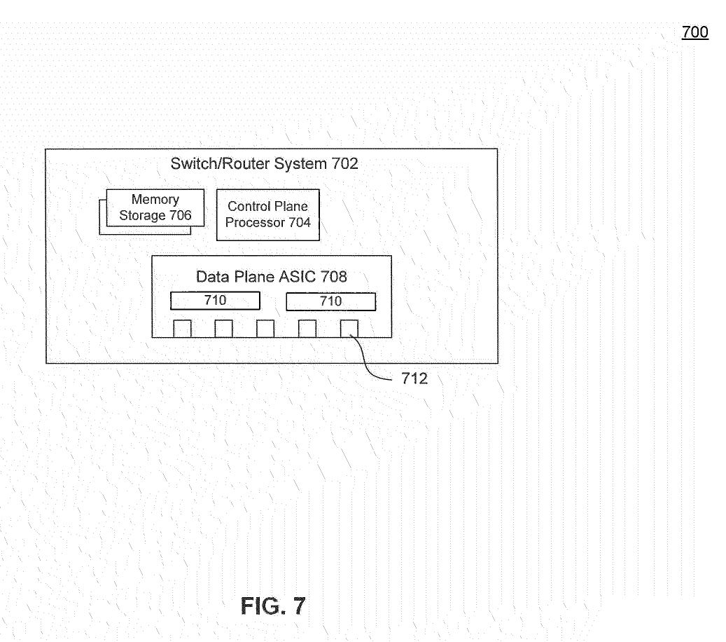

In an embodiment, block diagram 200 includes a hash table 210. Hash table 210 stores multiple hash functions 212, such as hash functions 212_1 though 212_{—}n, where each of hash functions 212 is selected based on a particular value of field 208. When each of hash functions 212_1 to 212_{—}n is applied to the immutable fields in packet 206, each hash functions 212_1 to 212_{—}n generates a hash which corresponds to a particular resource, such as an outgoing port of switch 104 that propagates a packet to the next switch 104 and/or to the next stage. A person skilled in the art will appreciate that hash functions 212 may also be stored in a memory storage, such as a memory storage described in FIG. 7 or other hardware or software machinery compatible with storing hash functions 212 within switch 104 or a router.

In an embodiment, hash functions 212_1 to 212_{—}n may be polynomial division remainder functions of the type used for pseudo-random sequence generation or error checking. In a further embodiment, hash functions 212_1 to 212_{—}n may be unrelated polynomial functions, such that one polynomial function is not a divisor of the other polynomials functions as to avoid correlation. In a further embodiment, hash functions 212_1 to 212_{—}n are static hash functions, that are not influenced by a time factor or data load. In yet a further embodiment, hash functions 212_1 to 212_{—}n are cyclic redundancy check (CRC) functions.

In an embodiment, block diagram 200 includes a hash function selector 214. Hash function selector 214 selects one of hash functions 212_1 to 212_{—}n using the value of field 208. For instance, hash function selector 214 may receive packet 206 that includes field 208. Hash function selector 214 then uses the value of field 208 to select one of hash functions 212_1 to 212_{—}n as the selected hash function 212_{—}s.

In an embodiment, block diagram 200 also includes a load balancing module 216. Load balancing module 216 uses hash function 212_{—}s selected using hash function selector 214 to determine a resource 218. Example resource 218 may be, a physical port which switch 104 uses to route packet 206 to the next switch 104 or to a destination, the address of the next switch 104, or other destination based resource. For example, load balancing module 216 may generate a hash value by applying hash function 212_{—}s to one or more immutable fields in packet 206. The values of the one or more immutable fields may be set by the source, in one embodiment. In another embodiment, the immutable fields are different from field 208. The generated hash value may correspond to, or identifies, a particular resource 218 such as a switch port that determines the next hop. In another embodiment, load balancing module 216 may take a modulus of the hash value, where the modulus of the hash value corresponds to resource 218.

Hence, because field 208 has a different value at each switch 104, hash function selector 214 selects a different hash function 212 from the available hash functions 212_1 to 212_{—}n as hash function 212_{—}s that is then used to select resource 218, such as an outgoing port for packet 206 at different switches 104. Thus, packets in two data flows that would conventionally generate the same hash value using the same hash function, and hence use the same outgoing port from switch to switch, would be sent along different paths in network 100 as long as their respective values of field 208 are different using the embodiments described herein. The selection at each hop is uncorrelated to the selection made at previous hops.

For data flows having a packet sequence constraint (such as TCP), hash generator 202 ensures a sequential transmission of packets 206 in the same data flow from a source to a destination, where the path of the data flow is a function of a value of field 208 that is different at each switch 104 (or in a multi-stage network, at each stage). However, even though the values of field 208 are different at each switch 104, the values of field 208 are the same for multiple packets 206 in the same data flow at a particular switch 104. The same values of field 208 at a particular switch 104 cause hash generator 202 to select the same resource 218 at each particular switch 104 for a given data flow. In this way, packets 104 within the same data flow travel along the same path in network 104 and therefore arrive in a sequential manner.

On the other hand, two data flows having a packet sequence constraint would travel along different or uncorrelated paths through network 100 with respect to each other. For example, packets in different data flows would conventionally travel along the same path when their respective immutable fields generate the same hash value when applied to the same hash function, where the same hash value corresponds to the same outgoing port. However, hash generator 202 forces the two data flows to travel along different paths because different respective values of field 208 in packets 206 from different data flows at the same switch 104 causes the hash function selector 214 to select different hash functions 212. Different hash functions 212 will cause load balancing module 216 to generate different hashes that correspond to different outgoing ports for packets 206 in the different data flows. This, in turn will cause packets 206 from different data flows to travel to different switches 104. Because hash generator 202 forces different data flows to travel along uncorrelated paths, hash polarization is eliminated in network 100.

In an embodiment, one or more switches 104 in network 100 may malfunction. In this embodiment, switch 104 may include a resilient hashing module (not shown). The resilient hashing module may redirect packets 206 to resources 218 that propagate packets 206 to functioning switches 104. For instance, the resilient hashing module may redirect packets 206 to a new resource 218 based on the hash value that selects resource 218 that leads to a malfunctioning switch 104 and the value of field 208. Because the value of field 208 remains constant within switch 104, resilient hashing module propagates packets 206 with the same value of field 208 to the same resource 218.

One of the benefits of the above embodiment is that data flows travel over network 100 without experiencing hash polarization at one or more switches 104 between a source and a destination. Another benefit of the above embodiment is that network 100 is wired without attempting to reduce hash polarization using a conventional approach which scrambles switch to switch wiring to alleviate polarization. Yet another benefit of the above embodiment is that switches 104 (or routers) may be deployed without local configuration of entropy or seed that may be conventionally used to alleviate hash polarization. In this way, the configuration in switches 104 does not require maintenance or updates to the configuration with respect to entropy or seed.

In an embodiment, hash generator 202 is implemented in switches 104 (or routers), or other devices that propagate data traffic through network 100.

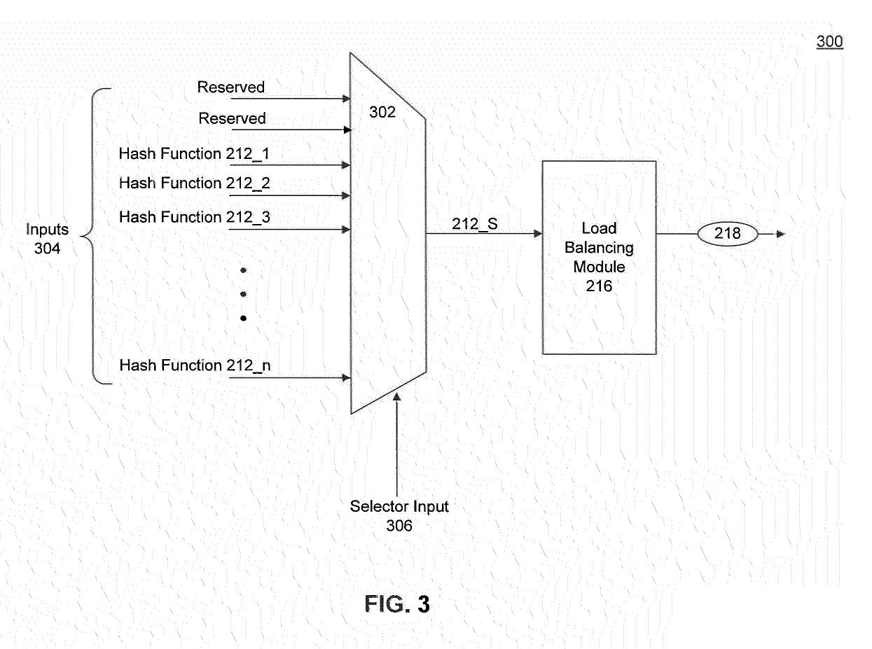

FIG. 3 is a block diagram 300 of a hardware implementation of a hash function selector, according to an embodiment, such as hash function selector 214.

In block diagram 300 hash function selector 214 may be a multiplexor 302. Multiplexor 302 includes multiple inputs 304 and a selector input 306. Based on the value of selector input 306, multiplexor 302 selects one of inputs 304. In an embodiment, multiplexor 302 includes hash functions 212_1 to 212_{—}n as inputs 304 and field 208 as a selector input 306. Each of hash functions 212_1 to 212_{—}n are encoded to a particular value of field 208.

In an embodiment, in FIG. 3, a value of field 208 may be four bits. The four bits translate into selector input 306 having sixteen distinct values. Some or all values of field 208 may be encoded to inputs 304, where each input 304 corresponds to a particular hash function 212_1 to 212_{—}n, as shown in Table 1. In an embodiment, some inputs 304 may be reserved for other functionality, although the implementation is not limited to this embodiment.

TABLE 1

| | Inputs 304 |
|---|---|
| Selector | |
| Input 306 | |
| 0000 | Reserved |
| 0001 | Reserved |
| 0010 | Reserved |
| 0011 | Hash Function 212_1 |
| 0100 | Hash Function 212_2 |
| 0101 | Hash Function 212_3 |
| 0110 | Hash Function 212_4 |
| 0111 | Hash Function 212_5 |
| Field 208 | |
| values 1000-1111 | |
| 1000 | Hash Function 212_6 |
| 1001 | Hash Function 212_7 |
| 1010 | Hash Function 212_8 |
| 1011 | Hash Function 212_9 |
| 1100 | Hash Function 212_n |
| 1101 | Reserved |
| 1110 | Reserved |
| 1111 | Reserved |

Based on the value of selector input 306, multiplexor 302 selects one of hash functions 212_1 to 212_{—}n that map to inputs 304, as shown in FIG. 3. Once multiplexor 302 selects hash function 212_{—}s, load balancing module 216 uses the selected hash function 212_{—}s to generate a hash value that maps to resource 218. For instance, load balancing module 216 may apply hash function 212_{—}s to one or more immutable fields in packet 206 (where the immutable fields are different from field 208) and generate a hash value. Once generated, load balancing module 216 may then use the hash value to select resource 118.

The “reserved” fields in Table 1 indicate that every value of the selector input 306 maps to hash functions 212. As a result, any of hash functions 212 may be mapped to repeat in the “reserved” fields.

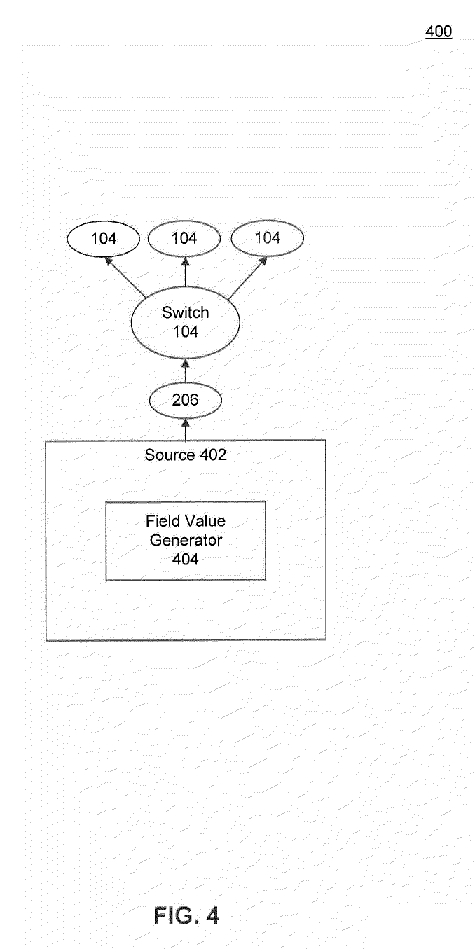

FIG. 4 is a block diagram 400 of a source that generates a value for a field in a packet, according to an embodiment. Block diagram 400, includes source 402. Source 402 may be a computing device, such as a computing device of FIG. 6 that includes a network interface controller (“NIC”) that prepares packet 206 for transmission over network 100. As part of the preparation, NIC appends a packet header to a packet 206.

In an embodiment, source 402 includes a field value generator 404. Field value generator 402 generates an initial field value for field 208. Because source 402 generates an initial field value for field 208, source 402 introduces source based traffic dispersion into the data flow as the data flow is transmitted over network 100. This type of configuration allows source 402 to change the path of a data flow through network 100 when one or more switches 104 in network 100 malfunctions.

In an embodiment, field value generator 404 may change the value of field 208 for packets 206 included in the same data flow. When the value of field 208 differs between packets 206 within the same data flow, packets 206 are no longer transmitted along the same path from source 402 to destination in network 100. Instead, packets 206 having a different value of field 208 are transmitted along different paths from source 402 to destination. In an embodiment, this type of a configuration increases aggregate network capacity of the data flow as network 100 transmits the data flow using multiple paths from source to destination. A person skilled in the art will appreciate that this embodiment may be used for data flows that do not have a sequential constraint, such as, UDP and HTTP flows.

In an embodiment, field value generator 404 generates a value of field 208 that is larger than the network diameter. A person skilled in the art will appreciate that the network diameter is a number of hops packet 206 makes between source 402 and a destination in a multi-stage network.

In this embodiment, source 402 can generate data flows that can be forwarded along multiple paths per data flow, and further control which data flows are subject to relaxed load balancing by generating different field 208 values using field value generator 404. Another benefit of the above embodiment, is that trouble shooting of a network 100 is state deterministic. For instance, when field value generator 404 sets field 208 to a particular value, the path of the packet 206 though network 100 may be predicted based on the value of field 208.

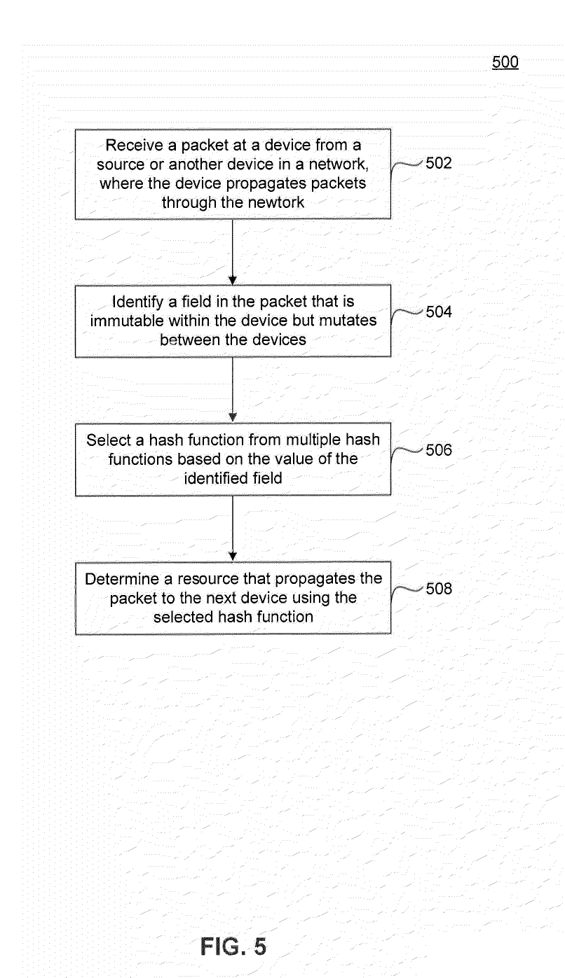

FIG. 5 is a flowchart of a method 500 for selecting a resource in a network, according to an embodiment.

At step 502, a hash generator receives a packet. For example hash generator 202 receives packet 206 from another switch 104 or source 402 in network 100.

At step 504, a packet field is identified. For example, field selector 204 selects field 208 in packet 206 that is immutable within switch 104 but is mutable between switches 104.

At step 506, a hash function is selected. For instance, based on the value of field 208 selected in step 504, hash function selector 214 selects hash function 212_{—}s. As discussed above, the value of field 208 maps to one of hash functions 212_1 to 212_{—}n stored in switch 104.

At step 508, a resource is determined based on the selected hash function. For example, load balancing module 216 uses hash function 212_{—}s and immutable fields in packet 206 to generate a hash value. Based on the value of the hash, or the modulus of the value of the hash, load balancing module 216 determines resource 218, such as port through which packet 206 is transmitted to the next switch 104 or destination in network 100.

Various aspects of the disclosure can be implemented by software, firmware, hardware, or a combination thereof FIG. 6 illustrates an example computer system 600 in which the embodiments, or portions thereof, can be implemented. For example, the methods illustrated by flowcharts described herein can be implemented in system 600. Various embodiments of the disclosure are described in terms of this example computer system 600. After reading this description, it will become apparent to a person skilled in the relevant art how to implement the disclosure using other computer systems and/or computer architectures.

Computer system 600 includes one or more processors, such as processor 610. Processor 610 can be a special purpose or a general purpose processor. Processor 610 is connected to a communication infrastructure 620 (for example, a bus or network).

Computer system 600 also includes a main memory 630, preferably random access memory (RAM), and may also include a secondary memory 640. Secondary memory 640 may include, for example, a hard disk drive 650, a removable storage drive 660, and/or a memory stick. Removable storage drive 660 may comprise a floppy disk drive, a magnetic tape drive, an optical disk drive, a flash memory, or the like. The removable storage drive 660 reads from and/or writes to a removable storage unit 670 in a well-known manner. Removable storage unit 670 may comprise a floppy disk, magnetic tape, optical disk, etc. which is read by and written to by removable storage drive 660. As will be appreciated by persons skilled in the relevant art(s), removable storage unit 670 includes a computer usable storage medium having stored therein computer software and/or data.

In alternative implementations, secondary memory 640 may include other similar means for allowing computer programs or other instructions to be loaded into computer system 600. Such means may include, for example, a removable storage unit 670 and an interface (not shown). Examples of such means may include a program cartridge and cartridge interface (such as that found in video game devices), a removable memory chip (such as an EPROM, or PROM) and associated socket, and other removable storage units 670 and interfaces which allow software and data to be transferred from the removable storage unit 670 to computer system 600.

Computer system 600 may also include a communications and network interface 680. Communication and network interface 680 allows software and data to be transferred between computer system 600 and external devices. Communications and network interface 680 may include a modem, a communications port, a PCMCIA slot and card, or the like. Software and data transferred via communications and network interface 680 are in the form of signals which may be electronic, electromagnetic, optical, or other signals capable of being received by communication and network interface 680. These signals are provided to communication and network interface 680 via a communication path 685. Communication path 685 carries signals and may be implemented using wire or cable, fiber optics, a phone line, a cellular phone link, an RF link or other communications channels.

The communication and network interface 680 allows the computer system 600 to communicate over communication networks or mediums such as LANs, WANs the Internet, etc. The communication and network interface 680 may interface with remote sites or networks via wired or wireless connections.

In this document, the terms “computer program medium” and “computer usable medium” and “computer readable medium” are used to generally refer to media such as removable storage unit 670, removable storage drive 660, and a hard disk installed in hard disk drive 650. Signals carried over communication path 685 can also embody the logic described herein. Computer program medium and computer usable medium can also refer to memories, such as main memory 630 mid secondary memory 640, which can be memory semiconductors (e.g. DRAMs, etc.). These computer program products are means for providing software to computer system 600.

Computer programs (also called computer control logic) are stored in main memory 630 and/or secondary memory 640. Computer programs may also be received via communication and network interface 680. Such computer programs, when executed, enable computer system 600 to implement embodiments of the disclosure as discussed herein. In particular, the computer programs, when executed, enable processor 610 to implement the processes of the disclosure, such as the steps in the methods illustrated by flowcharts discussed above. Accordingly, such computer programs represent controllers of the computer system 600. Where the disclosure is implemented using software, the software may be stored in a computer program product and loaded into computer system 600 using removable storage drive 660, hard drive 650 or communication and network interface 680, for example.

The computer system 600 may also include input/output/display devices 690, such as keyboards, monitors, pointing devices, etc.

Various aspects of the embodiments can be implemented by software, firmware, hardware, or a combination thereof as described in FIG. 7, FIG. 7 is an example block diagram 700 of a switch or a router system 702 (system 702) in which the embodiments can be implemented. For example, switches 104 and routers as discussed in network 100 and FIGS. 1-6 can be implemented in system 702.

System 702 includes a control plane processor 704. Control plane processor 704 may be processor 610 discussed in detail in FIG. 6. Control plane processor 704 controls operations, such as packet routing, policy algorithms, packet processing, etc.

In an embodiment, system 702 also includes a memory storage 706, such as a dynamic random-access memory (DRAM), static random-access memory (SRAM) or another random-access memory, though the implementation is not limited to these embodiments. Additionally, memory storage 706 may also include types of memories discussed in FIG. 6. In a further embodiment, memory storage 706 may be a monolithic memory storage that is designed as a high reliability mass storage and for fast application access. In an embodiment, memory 706 is accessible to components within system 702.

In an embodiment, memory storage 706 may store hash tables 210 and hash functions 212, discussed above.

In an embodiment, system 702 includes a data plane application-specific integrated circuit (ASIC) 708. Data plane ASIC 708 receives instructions from control plane processor 704 and based on these instructions routes packets to other destinations that include switches, routers, etc. For example, data plane ASIC 708 may use a multiplexor 302, hash function selector 214 and hash functions 212 to identify the next network port 712 that routes a packet to the next destination.

In an embodiment, data plane ASIC 708 includes an embedded buffer 710, such as an SRAM buffer. Embedded buffer 710 stores packets that system 702 receives from other switches, routers, etc., while data plane ASIC 708 performs processing to identify network port 712 for routing the packets to the next destination.

In an embodiment, system 702 also includes network ports 712. Network ports 712 allow packets to travel from switch to switch within system 702. In a further embodiment, network ports 712 may be network ports 110 discussed in FIG. 1.

The disclosure is also directed to computer program products comprising software stored on any computer useable medium. Such software, when executed in one or more data processing device(s), causes a data processing device(s) to operate as described herein. Embodiments of the disclosure employ any computer useable or readable medium, known now or in the future. Examples of computer useable mediums include, but are not limited to primary storage devices (e.g., any type of random access memory), secondary storage devices (e.g., hard drives, floppy disks, CD ROMS, ZIP disks, tapes, magnetic storage devices, optical storage devices, MEMS, nanotechnological storage device, etc.), and communication mediums (e.g., wired and wireless communications networks, local area networks, wide area networks, intranets, etc.).

Embodiments in the disclosure can work with software, hardware, and/or operating system implementations other than those described herein. Any software, hardware, and operating system implementations suitable for performing the functions described herein can be used.

It is to be appreciated that the Detailed Description section, and not the Summary and Abstract sections, is intended to be used to interpret the claims. The Summary and Abstract sections may set forth one or more but not all exemplary embodiments of the disclosure as contemplated by the inventor(s), and thus, are not intended to limit the disclosure and the appended claims in any way.

The embodiments have been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the disclosure that others can, by applying knowledge within the skill of the art, readily modify and/or adapt for various applications such specific embodiments, without undue experimentation, without departing from the general concept of the disclosure. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the specification is to be interpreted by the skilled artisan in light of the teachings and guidance.

The breadth and scope of the embodiments should not be limited by any of the above-described exemplary embodiments, but should be defined only in accordance with the following claims and their equivalents.

What is claimed is:

1. A system comprising:
a hash generator configured to:
identify a field in a packet, wherein the field is immutable within a first device and mutable between the first device and a plurality of other devices, wherein the first device and the plurality of other devices propagate the packet though a network;
select a hash function from a plurality of hash functions based on the identified field; and
determine, using the selected hash function, a resource within the first device, wherein the resource identifies one of the plurality of other devices in the network that is next to receive the packet.

2. The system of claim 1, wherein the hash generator is further configured to select a different hash function from the plurality of hash functions for a different value of the identified field.

3. The system of claim 1, wherein to determine the resource, the hash function generator is further configured to:
generate, using the selected hash function and an immutable field in the packet, a hash of the immutable field, wherein the immutable field is different from the identified field; and
generate a modulus of the hash, wherein the modulus of the hash corresponds to the determined resource.

4. The system of claim 1, wherein the first device is in a first stage of the network and the plurality of other devices are outside of the first stage, and wherein the field in the packet is immutable within the first stage and mutable outside of the first stage.

5. The system of claim 1, wherein the first device is a switch or a router.

6. The system of claim 1, wherein the hash function is a cyclic redundancy check (CRC) function.

7. The system of claim 1, wherein the field in the packet is a time to live (TTL) field.

8. The system of claim 1, wherein the hash generator is further configured to:
receive the packet including the field, wherein a value of the field is set at a source that initiates the packet transmission through the network.

9. The system of claim 8, wherein the value of the field is set to a value larger than a network diameter, wherein the network diameter indicates a number of hops a packet makes between the source and a destination.

10. The system of claim 8, wherein the source sets a different value to the field in different packets in a data flow, wherein the packets in the data flow travel from the source to a destination.

11. A method comprising:
identifying a field in a packet, wherein the field is immutable within a first device and mutable between the first device and a plurality of other devices, wherein the first device and the plurality of other devices propagate the packet though a network;
selecting a hash function from a plurality of hash functions based on the identified field; and
determining, using the selected hash function, a resource within the first device, wherein the resource identifies one of the plurality of other devices in the network that is next to receive the packet.

12. The method of claim 11, wherein the selecting further comprises selecting a different hash function from the plurality of hash functions for a different value of the identified field.

13. The method of claim 11, wherein determining the resource further comprises:
generating, using the selected hash function and an immutable field in the packet, a hash of the immutable field; and
generating a modulus of the hash, wherein the modulus of the hash corresponds to the determined resource.

14. The method of claim 11, wherein the first device is in a first stage of the network and the plurality of other devices are outside of the first stage, and wherein the field in the packet is immutable within the first stage and mutable outside of the first stage.

15. The method of claim 11, wherein the first device is a switch or a router.

16. The method of claim 11, wherein the hash function is a cyclic redundancy check (CRC) function.

17. The method of claim 11, wherein the field in the packet is a time to live (TTL) field.

18. The method of claim 11, further comprising:
receiving the packet including the field, wherein a value of the field is set at a source that initiates the packet transmission through the network.

19. The method of claim 18, wherein the value of the field is set to a value larger than a network diameter, wherein the network diameter indicates a number of hops a packet makes between the source and a destination.

20. The method of claim 18, wherein the source sets a different value to the field in different packets in a data flow, wherein the packets in the data flow travel from the source to a destination.
